(19) United States
(12) Patent Application Publication
(10) Pub. No.: US 2004/0102879 A1
(43) Pub. Date: May 27, 2004

(54) Glitch capture

(76) Inventors: Kurt Raichle, Owatonna, MN (US); Troy Liebl, Owatonna, MN (US); Edward Lipscomb, Lakeville, MN (US)

Correspondence Address: BAKER & HOSTETLER LLP, Washington Square, Suite 1100, 1050 Connecticut Avenue, N.W., WASHINGTON, DC, 20036, US

(21) Appl. No.: 10/303,896

(22) Filed: Nov. 26, 2002

(51) Int. Cl. G06F 19/00

(52) U.S. Cl. 701/29; 340/438

(57) ABSTRACT

A method and apparatus for displaying a glitch is provided. In one embodiment of the invention, an analyzer is provided that can display a glitch when it occurs for the operator to view and analyze. The analyze can also alert the operator when a glitch occurs in case the operator was distracted or was not paying attention to the display.

### FIELD OF THE INVENTION

Embodiments of the present invention generally relate to an analyzer. More specifically, the analyzer can notify the user of glitches while taking measurements.

### BACKGROUND OF THE INVENTION

In the past, vehicles were simple machines with simple components. Carburetors were used to control fuel and air intakes in the cylinder of the engine. Seat belts were the only main safety components located in the passenger compartment. In the past, when the brakes were suddenly applied during emergency maneuvers to avoid an accident, they would tend to lock up making the vehicle hard to control.

Today vehicles are very sophisticated with high tech components. Carburetors are replaced by fuel-injectors that are computerized for efficiency. Ignition of the spark plugs are also electronically controlled so that the spark plugs are fired in the correct order and at the appropriate time. Air bags are used in conjunction with seat belts for safety of the passengers in the passenger compartments. Anti-locks brakes are available to prevent the brakes from locking up during emergency maneuvers. Sensors are used to monitor the various components of the vehicle to ensure optimum performance. Onboard computers are installed on new vehicles so that maintenance and information from the sensors can be collected and logged.

A conventional digital analyzer can convert analog signals to digital signals for display on an oscilloscope. The oscilloscope displays snapshots of discrete portions of the signals as waveforms. In the case of an engine having multiple cylinders, waveforms showing the primary and the secondary ignition voltages can be displayed. The voltages are acquired from a primary and a secondary lead that are connected to an ignition coil. A synch probe may be attached to the first cylinder so that the analyzer can identify the cylinders (by knowing where in the sequence the first cylinder is) and determine the firing order of the cylinders. The analyzer can display sweeps, such as an engine sweep or a fixed time sweep. Engine sweeps can display a single cylinder ignition event or a complete cycle of ignition events. Additionally, the engine sweep may be displayed as cylinder, parade, or raster view. Cylinder sweep displays only a single cylinder waveform while the parade and raster display all the cylinders but in a horizontal progression or stacked vertically on top of one another, respectively. The fixed time sweep displays a fixed period of time in which the data is to be collected and shown as determined by a user.

While the analyzer is collecting data, the cylinder may misfire or not fire (a glitch) during the analysis of the cylinders. However, the data may be displayed too fast for the user to see that the cylinder misfired (ignition event signal is not present) and the data will just stream by. Thus, the analysis of the cylinder may be misdiagnosed and can cause delay in the repairs.

Therefore, there is a need for an analyzer that can alert the user when a glitch occurs. There is also a need for the analyzer to capture and display the glitch data for the user.

### SUMMARY OF THE INVENTION

Embodiments of the present invention generally provide for an analyzer that can detect and display glitches that occur in the data from a sensor. The analyzer can also alert an operator when a glitch occurs.

In one embodiment of the invention, an analyzing apparatus is provided and includes a controller that can capture data from a sensor of a vehicle, a display that can display data received from the sensor of the vehicle, and an alert portion that can alert when a glitch is detected by the controller, wherein the display and the alert portion can be in communication with the controller. The display can also alert an operator by flashing at least a portion of the display. The alert is at least one of visual alert, audible alert, tactile alert, other sensory alert, and a combination thereof. Additionally, the display can display data from the glitch on at least a portion of the display. The sensor can be selected from an ignition system sensor, an anti-brake locking system sensor, a mass-air flow system sensor, a fuel injector sensor, a throttle positioning sensor, an oxygen sensor, a fan sensor, a fuel pump sensor, a transmission controls sensor, a vehicle power sensor, an intake air temperature sensor, a vehicle speed sensor, an idle control sensor, and other vehicle related components. The glitch can be a deviation from at least one preset value of the data being analyzed. The glitch can be detected when at least one of the following values from the data is changed from a preset value for the sensor, namely width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof. The alert portion can alert via a pager, a fax, an email, a phone, a computer, a personal digital assistant, a remote device or any other means or devices that will alert an operator when the glitch has been detected. The glitch data can also be stored in a memory storing medium.

In another embodiment, a method of displaying a glitch is provided and can include the steps of monitoring data from a sensor of a vehicle, displaying a glitch data that can occur in the data from the sensor, and alerting an operator when the glitch occurs. The monitoring, displaying and alerting of the operator can be done by an analyzer. The displaying the glitch data can occur on at least a portion of a display. The glitch can occur when there is a deviation from at least one preset value of the data being monitored. The at least one preset value can be selected from width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof. The alert can be a visual alert, an audible alert, a tactile alert, other sensory alert, and a combination thereof. The alert can be via a pager, a fax, an email, a phone, a computer, a personal digital assistant, a remote device or any other means or devices that will alert the operator when the analyzer has detected the glitch.

In still another embodiment, a system for displaying data can include a means for monitoring data from a sensor of a vehicle, a means for displaying data from a glitch portion of the data, and a means for alerting an operator when the glitch occurs. The means for alerting can alert by flashing at least a portion of the means for displaying. The means for alerting can alert by at least one of visual alert, audible alert, tactile alert, other sensory alert, and a combination thereof. The glitch can be detected when at least one of the following values from the data is changed from a preset value for the sensor, namely width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof. The means for alert can alert via a pager, a fax, an email, a phone, a computer, a personal digital assistant, a remote device or any other means or devices that will alert the operator when the glitch has been detected.

In a further embodiment, an analyzing apparatus for a vehicle is provided and can include a data collector that collects data from a sensor of the vehicle, a display that displays a glitch data from the data being collected, and an alerter that alerts an operator when the glitch occurs, wherein the data collector is in communication with the display and the alerter.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of an analyzer.

FIG. 2 is an illustration of various wave forms on a display of the analyzer.

FIG. 3 illustrates a display of wave forms from a four cylinder engine.

### DETAILED DESCRIPTION OF THE PREFERRED EMBODIMENT

The embodiments of the present invention relate to an analyzer that can alert the user when abnormal data appears or a glitch appears on the analyzer. The glitch can be captured and displayed for the operator to view. The operator can also be alerted by the analyzer when the glitch occurs.

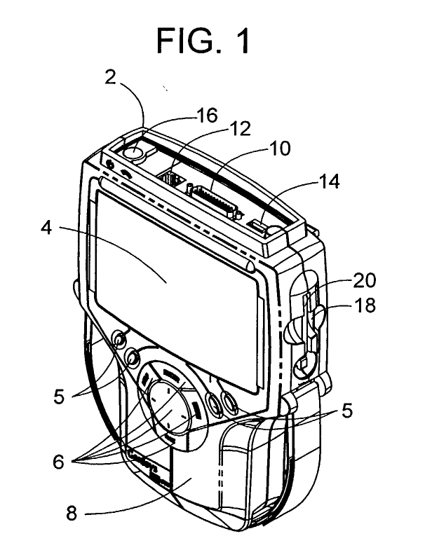

FIG. 1 is an illustration of an analyzer. The analyzer can be an oscilloscope or a graphing multimeter. In this figure, a handheld interface unit 2 has a display panel 4, a first button group 5, and a second button group 6. The handheld interface unit 2 is designed to provide a large display for ease of viewing, while providing a handle portion 8 that allows a user to grip the unit securely. The first button group 5 allows the bottom zone of the display to be assigned, as needed, as a row of four or more “soft keys” for changeable user interface options. The second button group 6 provides a set of switch closures independent of screen status, and serves as a primary user interface to the analyzer. Ports shown in FIG. 1 are a first custom interface connector 10 for an OBD, (On Board Diagnostic) adapter, a serial port connector 12, a USB (Universal Serial Bus) port connector 14, an Infrared Data Association (IrDA)/Hewlett-Packard (HP) Infrared connection 16, a PCMCIA type 2 connector 18 and a smart card connector 20. The interface unit 2 is shown as an example of the analyzer that can be used in the invention. The analyzer can take electrical data and convert them to useful information, such as a wave form, on the display. As the wave form traces across the screen, it displays the signal's characteristics for the operator to review, including any glitches that may occur during testing. The user can control the type of data displayed, the rate of sampling, and how fast the sample travel across the display.

The analyzer can connect directly with various sensors that are present in a vehicle or with the vehicle's computer. Preferably, the analyzer is connected directly with the vehicle's sensor. The sensors are designed to collect data from various components of the vehicle so that the components performance can be monitored. The sensors can relay information about components, such as the ignition system (monitor cylinder firing and ignition events), anti-brake locking system, mass-air flow system (intake airflow), fuel injectors, throttle positioning sensor (monitors the throttle as it relates to engine performance), oxygen sensors, fan sensors, fuel pump, transmission controls, vehicle power, intake air temperature, vehicle speed sensor, idle control, and other vehicle related components.

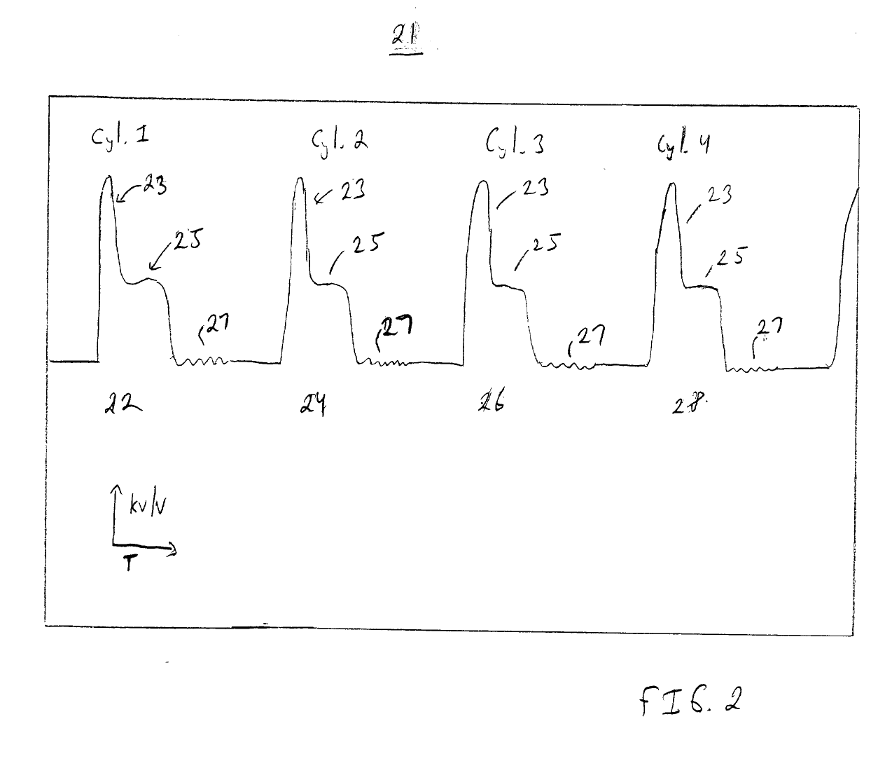

FIG. 2 is an illustration of various wave forms on a display 21 of the analyzer. The display 21 can display the wave form in various formats. The wave forms shown in FIG. 2 are secondary ignition wave forms that are the result of an ignition events that occur at each cylinder of an engine. The ignition wave form is exemplary, any wave form or other data graphs (numbers and charts, etc.) can be used and monitored with the invention. The secondary ignition wave forms represent ignition events from a four cylinder engine.

The secondary ignition wave forms show ignition events from cylinder one 22, cylinder two 24, cylinder three 26, and cylinder four 28. The x-axis can represent time (micro seconds, seconds or other time period) and the y-axis can represent voltage (kilovolts, volts or other voltage). The wave form for a cylinder will have an initial spike 23 and then drops to a “square” 25 and then back to the starting voltage 27. The amplitude of spike 23 indicates the amount of voltage needed to overcome all the air gaps in the secondary circuit, thereby increasing the voltage. The square represents spark Kv point or when current flow is established across the plug's gap. From the display 21, all of the wave forms indicate that all four cylinders are firing properly at the proper time.

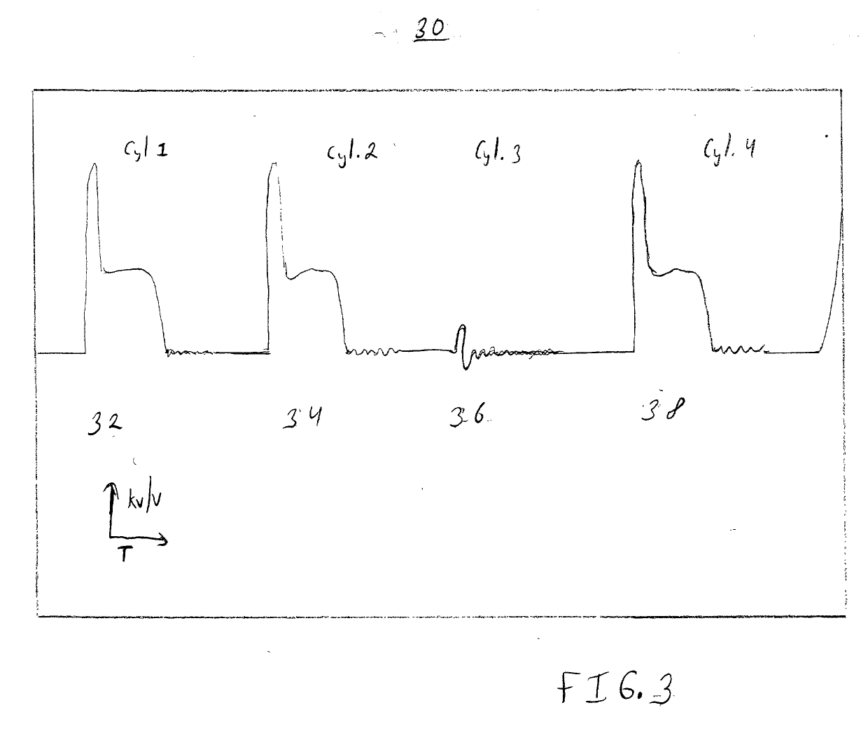

FIG. 3 illustrates a display of wave forms from a four cylinder engine. The wave forms from cylinder one 32, cylinder two 34, cylinder three 36 and cylinder four 38 of an engine that has a cylinder not functioning properly are shown. As seen in FIG. 3, all of the other cylinders' wave forms 32, 34, and 38 show that the ignition event occurred, as expected. However, the wave form for cylinder three 36 illustrates that the ignition event did not occur or that the ignition event occurred, but not enough to trigger any reading by the analyzer. The wave form 36 shows some background noise that the analyzer picked up.

The wave forms in FIGS. 2 and 3 are continuously displayed across the display screen at a rapid rate. A field programmable gate array (FPGA) or a microprocessor can be used to sample and display the wave forms. The FPGA is configured and arranged to operate as a conventional processor. An image of a soft-core microprocessor is loaded from the memory (i.e. flash, RAM, hard drives, other memory storage devices, etc.) into the FPGA. The FPGA controls and processes a number of different functions of the analyzer including monitoring the wave forms to alert the operator when the wave forms or other parameters that are being monitored are not within the normal parameters.

The FPGA can be set to monitor various sensor signals received by the analyzer. The FPGA can monitor changes in the signal's parameters, such as width, height, period, amplitude, frequency, amperage, voltage, r.p.m., resistance, current, temperature, throttle angle, speed, velocity, numerical value, time, pressure, volume, gas levels, liquid levels, air level, air/fuel ratio, other parameters and a combination thereof. If the operator is not paying attention or is distracted, he can miss a glitch or when the parameters being monitored deviates from the preset values. From FIG. 3, the operator can miss the misfiring of cylinder three and the associated wave form 36.

In an embodiment of the invention, the operator can be alerted when the parameters deviate from the set values or when a glitch occurs. The operator can be alerted or notified visually, audibly, tactilely, other sensory type alerts or a combination thereof. The operator can be alerted by a portion of the display flashing, the entire display flashing or a combination thereof. The flashing can be constant or can vary in frequency and intensity. The operator can also be alerted from sounds that can be constant, can vary in frequency, time or a combination thereof. Additionally, the operator can alerted by the analyzer vibrating, shaking, shocking, or a combination thereof. Other ways the operator can be alerted to the glitch can include via a pager, a fax, an email, a phone, a computer, a personal digital assistant, a remote device or any other means that will allow the operator to know that the analyzer has detected the glitch or that the parameters are beyond the set values. By being alerted to the glitch, the operator can know when the glitch occurs and can pay attention to the data that is being displayed. This is helpful to the operator when the operator is not paying attention.

As stated above, the analyzer runs a continuous display of the captured data and the operator can vary the speed. However, even if the operator slows down the display speed, he may still not visually see the glitch as it goes by. In another embodiment, once the glitch is detected, the glitch can be captured by the FPGA and displayed. The glitch can be stored on the on board memory or relayed to another remote device for further analysis. The glitch can also be stored on a removable medium, such as CDs, DVDs, flash drives, ZIP® tapes, floppy disc, optical disc and other medium that can store data. The FPGA can display the pertinent section that contains the glitch so that it will be easier for the operator. The glitch can be shown on the entire display or in a portion of the display. When the glitch appears in a portion of the display, the normal parameters values may also be displayed so that the operator can have some reference values to compare the glitch with. By having the glitch appear on the scope, the operator does not have to waste time to review the data stream for the glitch. Additionally, the glitch may not be readily identifiable to the operator that is manually looking the glitch data, so by having the glitch automatically displayed, the operator can be ensured that he is looking at the correct data in order to provide the correct diagnosis.

In another embodiment, the operator can be alerted and the glitch can be displayed. The operator can be alerted in any manner that is discussed herein and the analyzer can show the glitch on the display. The timing of the alert and the display can vary in relation to each other. For example, the alert occurs then the glitch is displayed, the glitch is displayed then the alert occurs, the glitch and alert can occur at the same time or variations thereof.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An analyzing apparatus, comprising:
a controller that captures data from a sensor of a vehicle;
a display that displays data received from the sensor of the vehicle; and
an alert portion that alerts when a glitch is detected by the controller, wherein the display and the alert portion are in communication with the controller.

2. The analyzing apparatus of claim 1, wherein the display can also alert an operator by flashing at least a portion of the display.

3. The analyzing apparatus of claim 1, wherein the alert is at least one of visual alert, audible alert, tactile alert, other sensory alert, and a combination thereof.

4. The analyzing apparatus of claim 1, wherein the display displays data from the glitch on at least a portion of the display.

5. The analyzing apparatus of claim 1, wherein the sensor is selected from a group consisting of an ignition system sensor, an anti-brake locking system sensor, a mass-air flow system sensor, a fuel injector sensor, a throttle positioning sensor, an oxygen sensor, a fan sensor, a fuel pump sensor, a transmission controls sensor, a vehicle power sensor, an intake air temperature sensor, a vehicle speed sensor, an idle control sensor, and other vehicle related components.

6. The analyzing apparatus of claim 1, wherein a glitch is a deviation from at least one preset value of the data being analyzed.

7. The analyzing apparatus of claim 1, wherein the glitch is detected when at least one of the following values from the data is changed from a preset value for the sensor, namely width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof.

8. The analyzing apparatus of claim 1, wherein the alert portion can alert by at least one of a pager, a fax, an email, a phone, a computer, a personal digital assistant, a remote device or any other means or devices that will alert an operator when the glitch has been detected.

9. The analyzing apparatus of claim 1, wherein the glitch data can be stored in a memory storing medium.

10. A method of displaying a glitch, comprising the steps of:
monitoring data from a sensor of a vehicle;
displaying a glitch data that occurs in the data from the sensor; and
alerting an operator when the glitch occurs.

11. The method of claim 10, wherein monitoring, displaying and alerting the operator is done by an analyzer.

12. The method of claim 10, wherein displaying the glitch data occurs on at least a portion of a display.

13. The method of claim 10, wherein the glitch occurs when there is a deviation from at least one preset value of the data being monitored.

14. The method of claim 13, wherein the at least one preset value can be selected from a group consisting of width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof.

15. The method of claim 10, wherein the alert is at least one of visual alert, audible alert, tactile alert, other sensory alert, and a combination thereof.

16. The method of claim 10, wherein the alert portion can alert by at least one of a pager, a fax, an email, a phone, a computer, a personal digital assistant, a remote device or any other means or devices that will alert an operator when the glitch has been detected.

17. A system for displaying data, comprising:
a means for monitoring data from a sensor of a vehicle;
a means for displaying data from a glitch portion of the data; and
a means for alerting an operator when the glitch occurs.

18. The system of claim 17, wherein the means for alerting can alert by flashing at least a portion of the means for displaying.

19. The system of claim 17, wherein the means for alerting can alert by at least one of visual alert, audible alert, tactile alert, other sensory alert, and a combination thereof.

20. The system of claim 17, wherein the glitch is detected when at least one of the following values from the data is changed from a preset value for the sensor, namely width, height, period, amplitude, frequency, amperage, voltage, r.p.m., temperature, throttle angle, speed, velocity, numerical value, time, pressure, volume, gas level, liquid level, air level, air/fuel ratio, other parameters and a combination thereof.

21. The system of claim 17, wherein the means for alert can alert via a pager, a fax, an email, a phone, a computer, a personal digital assistant, a remote device or any other means or devices that will alert the operator when the glitch has been detected.

22. An analyzing apparatus for a vehicle, comprising:
a data collector that collects data from a sensor of the vehicle;
a display that displays a glitch data from the data being collected; and
an alerter that alerts an operator when the glitch occurs, wherein the data collector is in communication with the display and the alerter.
